(19) United States
(12) Patent Application Publication
(10) Pub. No.: US 2013/0052300 A1
(43) Pub. Date: Feb. 28, 2013

(54) FAT REPLACERS AND FILLING MATERIALS

(71) Applicants: Els Ginette Alexander Dendooven, Grimbergen (BE); Van Sau Nguyen, Brussels (BE); Lutgart Van-Nieuwenhuyze, Herdersem-Aalst (BE); Ronny Leontina Marcel Vercauteren, Beveren (BE)

(72) Inventors: Els Ginette Alexander Dendooven, Grimbergen (BE); Van Sau Nguyen, Brussels (BE); Lutgart Van-Nieuwenhuyze, Herdersem-Aalst (BE); Ronny Leontina Marcel Vercauteren, Beveren (BE)

(21) Appl. No.: 13/696,113

(22) PCT Filed: May 4, 2011
(86) PCT No.: PCT/US2011/035180

§ 371 Date: Nov. 5, 2012

Related U.S. Application Data
(60) Provisional application No. 61/331,352, filed on May 4, 2010.

(51) Int. Cl. A23L 1/09; A23L 1/307

(52) U.S. Cl. 426/3; 426/48; 426/658; 426/549; 426/639; 426/660; 426/573; 426/659; 426/582; 426/633; 426/603; 426/601; 426/531; 426/656; 426/661; 426/640

(57) ABSTRACT

The present invention relates generally to fat replacers and their use in various food products. Aspects of the disclosure are particularly directed to oligodextran-based fat replacers that are lower in calories, heat stable, and increase fiber. They can either be used alone or in combination with other additives to decrease the fat content while maintaining good organoleptic properties.

### CROSS REFERENCE TO RELATED APPLICATION

This application claims the benefit of the U.S. Provisional Patent Application Ser. No. 61/331,352, filed May 4, 2010, entitled FAT REPLACERS AND FILLING MATERIALS, which is hereby incorporated by reference in its entirety.

### FIELD

The present invention relates generally to fat replacers and their use in various food products. Aspects of the disclosure are particularly directed to low molecular weight based fat replacers that are lower in calories, heat stable, and increase fiber. They can either be used alone or in combination with other additives to decrease the fat content while maintaining good organoleptic properties.

### BACKGROUND

There is a strong need in finding low calorie alternatives to fats, oils, and lipids which have high caloric value and can carry other associated health issues such as raising cholesterol. There are a number of fat substitutes (or fat replacers) currently on the market such as fat-based, carbohydrate-based, and protein-based substitutes, but they have certain limitations and deleterious side effects. One well-known example of a fat-based fat substitute is olestra (Olean®), which does not add calories, fat or cholesterol to the diet. However, if large amounts are consumed, it can cause abdominal cramping and loose stools. While other fat substitutes can reduced caloric intake or will not raise cholesterol, these compounds have their own particular limitations as well. Sugar-based or carbohydrate-based fat substitutes such as dextrins, maltodextrins, gums, cellulose, gelatin, gels, fibers, pectins and modified food starches are commonly used due to the reduced caloric value they provide, but they suffer from the inability to replace fat's cooking or baking qualities. Protein-based fat substitutes including whey proteins (such as Simpless®) also have lower caloric value, but are unable to withstand high temperatures.

U.S. Pat. No. 5,141, 858 (the '858 patent) discloses a process for producing oligodextrans via enzymatic preparation and the purified oligodextran product using sucrose and a sugar acceptor including maltose in a ratio of between 0.5:1 to 10:1 as expressed in g/l. The process leads to the production of oligodextrans containing glucosidic α(1→2) bonds that make up 30 to 55% of the total oligodextrans. These all α(1→2) glucoside bonds create a molecule that is highly branched, and are typically in the average molecular weight (Mw) range of between 600-1200 daltons (Da) as they have a degree of polymerization of 4,5, 6 and 7 (D.P.4, D.P. 5, D.P.6, and D.P.7). In contrast, the present invention allows for the production of a very low molecular weight oligodextran mixture (2,000 to 20,000 Mw) that is highly linear due to its high content of α(1→6) glucoside bonds. This highly linear structure allows alignment and interaction of the molecules with each other to precipitate out and crystallize in a reasonable amount of time. Furthermore, the resulting product is non-digestible because it is insoluble, allowing for its effective use a fat replacer with a lower caloric value than fat.

Application WO/2002/017884 discloses a method of producing a high purity hydrogel, which is a hydrophilic polymeric network containing large amounts of water, from low molecular weight dextran (preferably less than 20,000 Mw), for use in medical, veterinary, pharmaceutical and biotechnological applications. However, because of the need for purity of the resulting product, crystallization of the dextran to form the hydrogel occurs out of the aqueous solution without the use of enzymes, organic solvents or other chemicals. Also, high purity dextran is used that does not contain glucose, fructose nor leucrose. U.S. Pat. No. 6,476,204 similarly discloses a process for making pharmacy-grade hydrogels from dextran, but with a weight average molecular weight of between 40,000 to 80,000 on a dextran basis.

A need therefore exists for a healthy fat replacer that can behave and look like fat without the high caloric value, with reduced or no cholesterol, which is heat stable and can be used in a wide variety of food products.

### SUMMARY

In view of the above, it is an object of the present invention to provide a healthy, low calorie, heat stable fat replacer that precipitates and behaves like fat. One embodiment is directed toward a method of producing a fat replacer comprising mixing a saccharide and an acceptor in a ratio of between 10:1 to 60:1 by weight (w/w) in an aqueous solution to form a syrup mixture, treating the syrup mixture with an enzyme to form an oligodextran mixture, and concentrating the oligodextran mixture to form a fat replacer containing oligodextran. In an alternative embodiment, further steps in the process comprise deactivating the enzyme, filtering the oligodextran mixture, and demineralizing the oligodextran mixture. In another embodiment, the ratio of the saccharide and the acceptor is of between 20:1 to 40:1 by weight (w/w).

In another embodiment, the saccharide comprises sucrose, the acceptor comprises maltose, and the enzyme comprises dextransucrase. In a further embodiment, the concentration of the enzyme is between 1.0 DNS to 3.0 DNS (where one di-nitro-salicylic acid (DNS) unit is defined as the amount of enzyme that catalyzes the formation of 1 μmol of fructose per minute at 30° C. in 20 mM of sodium acetate buffer pH 5.4 with 100 g/L of sucrose), and the concentration of the oligodextran in the fat replacer is between 60% dry solids (ds) Brix to 95% ds Brix and having a mean molecular weight (MW) of about 2,000 daltons to 20,000 daltons. In another embodiment, the treating step is performed at a pH of between 3.5 to 7.0 at a temperature of between 20° C. to 40° C. for a time of between 6 hours to 72 hours. In an alternative embodiment, the treating step is performed at a pH of 5.5, at a temperature of 30° C. for a time of between 12 hours to 48 hours. In one embodiment, the treating steps are performed by a continuous immobilized enzyme process.

In an alternative embodiment, the deactivating step comprises adjusting the pH of the oligodextran mixture to a pH of between 2.0 to 3.2, or adjusting the temperature of the oligodextran mixture to a temperature of between 45° C. to 100° C. for a time of between 0.02 hours to 4 hours. In another embodiment, the deactivating step comprises either adjusting the pH of the oligodextran mixture to a pH of 3, or adjusting the temperature of the temperature of the oligodextran mixture to a temperature of between 45° C. to 90° C. for a time of between 0.03 hours to 3 hours.

In one embodiment, a fat replacer composition comprises an oligodextran, fructose, glucose, leucrose and other di- and oligo-saccharides, wherein the composition has between 75% ds Brix to 95% ds Brix, the oligodextran component of the composition having a mean MW of about 2,000 to 20000 Da, and is greater than 90% linear with α1,6 linkage in the main chain. In addition, less than 10% of glucose is in the branches coming off the main chain of the oligodextran.

Another embodiment includes the use of the fat replacer described above in a food product, where the food product comprises bakery products, including biscuits, donuts, cakes, pastries, muffins, breads, and cookies; snacks, including candied fruits, nougat crumbs, expanded snacks, dates, bars, chips, and dried fruits; confectionery products, including hard and soft candies, chewing gums, dragees, jelly beans; food fillings, jellies, jams, marmalades, chocopaste, fudges, honey, processed cheese, cream cheese, peanut butter, honey replacers, margarine, butter and lard.

In a further embodiment, the use of the fat replacer composition in a food product also comprises adding one or more additives comprising a fat substitute, bulking agent, filling material, fat, lipid, oil, or combinations thereof. In a further embodiment, the use of the fat replacer composition in a food product by adding one or more additives includes the fat substitute comprises a fat-based, carbohydrate-based, or protein-based fat substitutes. The fat-based fat substitutes comprise olestra, caprenin, and salatrim. The carbohydrate-based fat substitutes comprise dextrins, maltodextrins, gums, cellulose, gelatin, gels, fibers, pectins, cellulose, inulin, oatrim, polydextrose, polyols, starch, and modified food starches, modified cellulose, beta-glucans, arabinoxylans. The protein-based fat substitutes comprise microparticulated proteins and whey proteins. The bulking agent comprises polydextrose, hydrocolloids, erythritol, glucose syrups, psicose and lignin. Finally, the filling material comprises gels, creams, and other similar materials.

In one embodiment, a reduced fat food product comprises a food product and a fat replacer, where the food product comprises a bakery product, or a confectionery product, and where the fat replacer comprises an oligodextran along with fructose, glucose, leucrose and other oligosaccharides, and the oligodextran has between 75% ds Brix to 95% ds Brix with a mean MW of about 2,000 to 20000 Da, and is greater than 90% linear with α1,6 linkage in the main chain.

In a further embodiment, the fat replacer composition also comprises one or more additives comprising a fat substitute, bulking agent, filling material, fat, lipid, oil, or combinations thereof. The fat substitute comprises a fat-based, carbohydrate-based, or protein-based fat substitutes. The fat-based fat substitutes comprise olestra, caprenin, and salatrim. The carbohydrate-based fat substitutes comprise dextrins, maltodextrins, gums, cellulose, gelatin, gels, fibers, pectins, cellulose, inulin, oatrim, polydextrose, polyols, starch, and modified food starches. The protein-based fat substitutes comprise microparticulated proteins and whey proteins. The bulking agent comprises polydextrose, hydrocolloids, erythritol, glucose syrups, psicose and lignin. Finally, the filling material comprises gels, creams, and other similar materials. In a further embodiment, the food product comprises bakery products, including biscuits, donuts, cakes, pastries, muffins, breads, and cookies; snacks, including candied fruits, nougat crumbs, expanded snacks, dates, bars, chips, and dried fruits; confectionery products, including hard and soft candies, chewing gums, dragees, jelly beans; food fillings, jellies, jams, marmalades, chocopaste, fudges, honey, processed cheese, cream cheese, peanut butter, honey replacers, margarine, butter and lard.

The present invention has several benefits, including being a healthy fat replacement that will disperse and dissolve in the mouth (solubilization of some of the ingredients) that is heat stable and will not readily disintegrate, lower in calories than regular fat products (about 3.2 kcal/g on dry substance compared to fat, which has 9 kcal/g), increases fiber since dextran is a fiber, which has 9 kcal/g), increases fiber (since dextran is a fiber), and it precipitates and behaves/acts like fat.

### DETAILED DESCRIPTION

### Selected Definitions

As used herein, the following terms shall have the following meanings:

The term “saccharide” as used herein refers to an organic molecule with the generic formula Cₘ(H₂O)ₙ. Saccharides include low molecular weight carbohydrates such as monosaccharides and disaccharides, to higher molecular weight carbohydrates such as oligosaccharides and polysaccharides. Monosaccharides are the smallest saccharides having a basic formula of (C.H₂O)ₙ where n ranges from three to seven. Common monosaccharides include molecules such as glucose, fructose, galactose, ribose and xylose. Disaccharides are comprised of two monosaccharide molecule joined together by a glycosidic linkage and have the general formula of C₁₂H₂₂O₁₁. The most common disaccharide is sucrose, which is comprised of D-glucose and D-fructose. Other dissacharides include molecules such as lactose, maltose, isomaltose, maltulose, high fructose corn syrup, and trehalose. Oligosaccharides are multi-chain monosaccharides linked together by glycosidic bonds that generally consist of three to ten monosaccharides. Polysaccharides are also multi-chain monosaccharides linked together by glycosidic bonds but generally consist of more than ten monosaccharides linked together. Common polysaccharides are starch and cellulose.

The term “sugar” as used herein refers to a saccharide molecule such as a monosaccharide or a disaccharide.

The term “acceptor” as used herein refers to a molecule that accepts the transfer of a functional group from another compound (sometimes referred to as the donor molecule) in the presence of an enzyme that catalyzes the transfer. Potential acceptors include maltose, maltose containing syrups like very high maltose syrup with 75-80% maltose content, dextrose, glucose syrups, isomaltose, isomaltotriose, isomalto-oligosaccharides, isomaltulose, sorbitol, maltitol, isomalt, ethyl-alpha-D-glucoside.

The term “syrup mixture” as used herein refers to the combination of the saccharide and the acceptor that are mixed together. They are preferably mixed in an aqueous solution.

The term “enzyme” as used herein refers to a compound, typically a protein, which acts as a catalyst in the chemical reaction to convert a saccharide into an oligodextran mixture.

The term “oligodextran mixture” as used herein refers to the compound resulting from the enzymatic catalyzation of a sugar in the presence of an acceptor. It comprises a low molecular weight polymer comprising oligodextran, preferably in the range of 2000-20000 daltons (Da). The oligodextran mixture can also contain fructose, glucose, leucrose and other disaccharides and oligosaccharides that make up to 60-65% of the weight of the carbohydrates in the mixture.

The term “oligodextran” as used herein refers to an oligosaccharide glucose polymer linked at α-1,6 position with the formula of H(C₆H₁₀O₅)ₓOH that results from the enzymatic reaction of a saccharide with an acceptor. In particular, the reaction of sucrose in the presence of an acceptor such as maltose results in the formation of an oligodextran (among other compounds). Although oligodextran is a multi-chain glucose polymer, it is a smaller chain molecule similar to an oligosaccharide, having an average molecule weight of about 2,000-20,000 Da. In contrast, a dextran is a polysaccharide glucose polymer comprising high molecular weight molecules that can range from 40000 up to hundreds of million daltons. Oligodextran is thus a low molecular weight dextran. The dextransucrase enzymes used in this invention are enzymes that synthesize dextrans and oligodextrans composed of more than 90% of alpha-1-6-linked D-glucose moieties together in the main chain. Ten percent or less are glucose molecules that are forming branches off of the main chain.

The term “fat replacer” as used herein refers to the oligodextran mixture demineralized and concentrated that can be used in a variety of food products. The fat replacer contains oligodextran from the oligodextran mixture. In some cases (eg bread), also use can be made of the non-demineralized product.

The term “mixing” as used herein refers to the step on the process of producing a fat replacer by combining the saccharide and acceptor to form a syrup mixture.

The term “treating” as used herein refers to the step of converting the syrup mixture into an oligodextran mixture with an enzyme by treating it for a period of time. One method is by incubating the syrup mixture with the enzyme in an aqueous solution. An alternative method is a continuous immobilized enzyme process.

The term “deactivating” as used herein refers to the step of inactivating the enzyme from continuing to act as a catalyst for the conversion of the syrup mixture into an oligodextran mixture.

The term “filtering” as used herein refers to the step of removing any impurities from the oligodextran mixture by means commonly known in the art.

The term “DNS” as used herein refers to the dextransucrase activity as determined by measuring the release of reducing sugar (fructose) with the di-nitro-salicylic acid (DNS) reagent according to the method described by Sumner in Sumner J. & Howell S. (1935), J.Biol.Chem., 108, pp 35 51-54. One unit is defined as the amount of enzyme that catalyzes the formation of 1 μmol of fructose per minute at 30° C. in 20 mM of sodium acetate buffer pH 5.4 with 100 g/L of sucrose.

The term “demineralizing” refers to the step in the process of removing cationic and/or anionic impurities present in the oligodextran mixture such as ash, protein, organic acids or combinations thereof. Conventional methods of demineralizing sugar-based solutions include using a cation exchange resin and an anion exchange resin respectively.

The term “continuous immobilized enzyme process” as used herein refers to one treating step route to produce the oligodextran fat replacer by using an immobilized dextransucrase instead of the soluble enzyme. In this way, there is no need to have a de-activation step of the enzyme and can use a lighter refining step. Also, because of the immobilization, the enzyme can be re-used and can be put into a heated column. As such, a continuous process becomes possible. Immobilization can be done using one of the conventional methods like adsorption onto an ion-exchange resin, entrapment in alginate-CaCl cell, or adsorption on silica.

The term “concentrating” as used herein refers to the step of condensing down the oligodextran mixture to form a fat replacer by means known in the art, including evaporation, reverse osmosis, nanofiltration, or dialysis.

The term “food product” as used herein refers to an edible product fit for consumption, including bakery products such as biscuits, donuts, pastries, cakes, and cookies; snack products such as candied fruits, nougat crumbs, expanded snacks, dried fruits, jellies, jams, and marmalades; confectionery products including hard and soft candies, chewing gums, dragees, and jelly beans, food fillings, and other similar products.

The term “sucrose” as used herein refers to a dissacharide molecule with the molecular formula of C₁₂H₂₂O₁₁ that is derived from glucose and fructose. Sucrose comes from plant sources such as sugar cane or sugar beets and is often referred to as table sugar.

The term “maltose” as used herein refers to a dissacharide molecule with the molecular formula of C₁₂H₂₂O₁₁ that is comprised of two glucose molecules linked at the α-1,4 position.

The term “dextransucrase” as used herein refers to an enzyme that is a glucosyltransferase that catalyzes the synthesis of soluble oligodextran from sucrose or saccharides when acceptor molecules such as maltose are present. The resulting compound includes oligodextran, which is a low molecular mass oligosaccharide. Dextransucrase is available from the Leuconostoc mesenteroides NRRL B-512F bacteria. This dextransucrase (E.C.2.4.1.5) produces essentially linear dextrans and oligodextrans, of which around 95% of the-D-glucose moieties are linked by an alpha-1-6 glucoside link. Other dextransucrases that produce linear dextrans (>90% of linkages are alpha-(1-6)-D-glucosidic linkages in the main chain) are: Leuconostoc mesenteroides NRRL B-1146, L.m.B-1064, L.m. B-1414, L.m. B-1145, L.m. B-640, L.m.B-1066, L.m. B-1208, L.m. B-1210, L.m. B-1211, L.m.B-1308, L.m. B-1209, L.m. B-1119, L.m. B-1072, L.m.B-1198, L.m. B-1212, L.m. B-1380, L.m. B-1405, L.m.B-1412, L.m. B-1413, L.m. B-1417, L.m. B-1442, L.m.B-1204, L.m. B-1214, L.m. B-1197, L.m. B-1307, L.m. B-1388, L.m. B-1191. Leuconsotoc dextranicum CM6713. Of course also other microorganisms can produce linear dextrans, like the Lactobacillus reuterii and Streptococcus sp.

The term “fat substitute” as used herein refers to fat-based, carbohydrate-based, and protein-based fat substitutes. Fat-based fat substitutes can act as a barrier to block fat absorption or are indigestible, thereby having no calories that are absorbed by the body. Fat-based fat substitutes can include olestra (commercially available as Olean®) which is a hexa-, hepta- or octa-ester of sucrose (table sugar) and fatty acids, caprenin (a triglyceride compound comprising the fatty acids capric, caprylic and behenic fatty acids esterified to glycerol, having a caloric value of 4 kcal/g), and salatrim (an acronym for short and long chain acyl triglyceride molecules, which are prepared by interesterification of triacetin, tripropionin, or tributyrin, or their mixtures with either hydrogenated canola, soybean, cottonseed, or sunflower oil and removal of triglycerides with three short-chain fatty acids in the process). Carbohydrate-based fat substitutes have reduced caloric value as compared to fats (from 0 to 4 kcal/g), and can include dextrins, maltodextrins, gums, cellulose, gelatin, gels, fibers, pectins, cellulose, inulin, oatrim, polydextrose, polyols, starch, modified food starches, modified cellulose, beta-glucans, and arabinoxylans. Protein-based fat substitutes also have lower caloric value than fats as well (about 4 kcal/g) and can include microparticulated protein and whey proteins extracted from egg whites and milk.

The term “bulking agent” as used herein refers to other products that can act as a partial replacement for fat including polydextrose, hydrocolloids, erythritol, glucose syrups, psicose and lignin.

The term “filling material” as used herein refers to any compound that can be used in a fat-containing product as a replacer or in a food product. Conventional filling materials can include gels, creams, and other similar materials.

The teem “fat” as used herein refers to any fat compound such as fats, lipids, and oils. Fats are generally solid at room temperature, while oils are generally liquid at room temperature, with lipids can contain both liquid and solid fats.

The following description of the invention is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein.

### Method for Producing a Fat Replacer

As shown by the examples and tests run, the present invention discloses a method for producing a fat replacer by mixing a saccharide and an acceptor in a ratio of between 10:1 to 60:1 by weight (w/w) to form a syrup mixture, treating the syrup mixture with an enzyme to form an oligodextran mixture, and concentrating the oligodextran mixture to form a fat replacer containing oligodextran. The method allows for the production of a fat replacer that is an oligodextran-based compound useful in a variety of food products. It can reduce the amount of fat used while maintaining similar organoleptic properties to fat as shown by the tests on products such as pound cake and biscuits.

The method comprises mixing a saccharide and an acceptor in a ratio of between 10:1 to 60:1 by weight to form a syrup mixture. The saccharide and acceptor can be mixed in an aqueous solution to allow sufficient mixing of the compounds and also to allow the enzymatic reaction to take place in the treating step. The saccharide can comprise a molecule such as sucrose, the acceptor can be a molecule such as maltose, and the enzyme can be a molecule such as dextransucrase. Sucrose is a relatively inexpensive and readily available source material for the reaction, as is maltose. Dextransucrase is commercially available and is also available from Cargill, Incorporated.

After the saccharide and acceptor are mixed together to form a syrup mixture, the enzyme incubates the syrup mixture to form an oligodextran mixture. The sucrose molecule can react in the presence of an acceptor molecule such as maltose and an enzyme. Specifically, the enzyme cleaves a glucose molecule from the sucrose molecule, releasing fructose and making an oligodextran polymer linked at the α1, 6 position (starches are linked at 1, 4 position). The result is a low molecular weight oligodextran mixture.

In one embodiment, the concentration of the enzyme is between 1.0 DNS U/g to 3 DNS U/g. The treating step can be performed at a pH of between 3.5 to 7.0, in another embodiment between 5.0 to 6.0 and in another embodiment at 5.5. The temperature can be between 20° C. to 40° C., in another embodiment at 30° C., for a time of between 6 hours to 72 hours, preferably between 12 hours to 48 hours.

In one embodiment, the treating step is performed by a continuous immobilized enzyme process by using an immobilized dextransucrase instead of the soluble enzyme. In this way, there is no need to have a de-activation step of the enzyme. Also, because of the immobilization, the enzyme can be re-used and can be put into a heated column. As such, a continuous process becomes possible. Immobilization can be done using one of the conventional methods like adsorption onto an ion-exchange resin, entrapment in alginate-CaCl cell, or adsorption on silica.

Once the enzymatic treatment occurs, thereby converting the syrup mixture into an oligodextran mixture, the oligodextran mixture can undergo a concentration step to form a fat replacer with oligodextran. This step can include using such methods known in the art such as evaporation, reverse osmosis, nanofiltration, or dialysis. In one embodiment, the concentration of the fat replacer is 60% ds Brix to 95% ds Brix with the oligodextran having a mean molecular weight between 2,000 and 20,000 daltons.

Alternatively, the enzyme can be deactivated by heat or pH modification. Specifically, the pH of the oligodextran mixture can be adjusted to about 2.0 to 3.2 by the addition of an acid such as hydrochloric acid (HCL) for a time between 0.02 hours to 4 hours. The enzyme can also be deactivated by increasing the temperature of between 45° C. to 100° C. for a time between 0.02 hours to 4 hours.

After the enzyme is deactivated, other unwanted compounds such as ash, protein, organic acids, or other compounds can be removed from the oligodextran mixture by optionally filtering and demineralizing it. In one embodiment, these compounds can be removed by using a cation exchange resin to remove the cationic impurities, and an anion exchange resin can be used to remove anionic impurities.

In an alternative embodiment, the syrup mixture can also be treated with a fructose converting enzyme to reduce the amount of fructose present in the oligodextran mixture and resulting fat replacer. Specifically, the fructose enzyme converts some of the fructose to glucose. An example of a fructose enzyme is glucose isomerase (EC 5.3.1.5), used most frequently as immobilized glucose isomerase (IGI). This allows a reduction of the fructose levels in the oligodextran mixture from about 40% w/w to about 20% w/w.

The isomerization of fructose to glucose can also be catalyzed by a base such as sodium hydroxide (NaOH). The base can be soluble molecule, but also in the solid form, such as a strong basic anion exchanger (polystyrene divinylbenzene matrix, substituted with quaternary ammonium groups). Also, certain ceramics and minerals, including aluminum oxides and hydrotalcites, are known to catalyze the fructose to glucose isomerization.

### Fat Replacer Composition

The fat replacer composition of the present invention has unique characteristics that allow it to function like a fat. It comprises low molecular weight oligodextrans, as well as fructose, glucose, leucrose and other oligosaccharides. The composition has between 70% ds Brix to 95% ds Brix with the oligodextran component having a mean molecular weight between 2,000 and 20,000 daltons. In addition, it is greater than a 90% linear chain with α1,6 glucoside linkage in the main chain. Finally, there is less than 10% of glucose in the branches coming off of the main chain.

In one embodiment, the composition can reduce the amount of fat used in a food product by 25% to 33% or even higher percentages of fat reduction. Since oligodextran is a fiber, it is a good source of fiber and can provide a feeling of fullness or satiety to the diet. In addition, it can result in a reduction of calories consumed as oligodextran contains about 3.2 kcal/g on dry substance compared to 9 kcal/g for fat. It can be used in a wide variety of food products, including but not limited to bakery products, including biscuits, donuts, cakes, pastries, muffins, breads, and cookies; snacks, including candied fruits, nougat crumbs, expanded snacks, dates, bars, chips, and dried fruits; confectionery products, including hard and soft candies, chewing gums, dragees, jelly beans; food fillings, jellies, jams, marmalades, chocopaste, fudges, honey, processed cheese, cream cheese, peanut butter, honey replacers, margarine, butter and lard. Use in these products can lead to a reduction of fat and calories consumed. Further, as seen by the examples below and the visual and sensory tests on the examples, the food products with the fat replacer composition can have organoleptic properties comparable to those found in products using fat. For example, cakes made using the fat replacer composition can be just as soft if not softer than those made with margarine. And higher specific volume. Higher amounts of fat replacer composition in the food product can lead to a slightly darker color and more browning, particularly as more of the composition is used. Nonetheless, acceptable taste and visual appearance can be obtained.

In a further embodiment, the fat replacer composition used in a food product can also include one or more additives such as a fat substitute, bulking agent, filling material, fat, lipid, oil, or combinations thereof. In combination with other fat substitutes, the fat replace compound can lead to further reduction of fat used and calories consumed while minimizing the limitations of fat substitutes currently available, such as sensitivity to high temperatures and non-fat properties. Combining the fat replacer composition with bulking agents and filling materials can also lead to an overall decrease in fat-consumption and calories while maintaining the satiety found with fat-containing products, as many bulking agents and filling materials can provide a feeling of fullness.

In an alternative embodiment, a reduced fat food product comprises a food product and a fat replacer, where the food product comprises a bakery product, or a confectionery product, and where the fat replacer comprises an oligodextran along with fructose, glucose, leucrose and other oligosaccharides, and where the fat replace is between 70% ds Brix to 95% ds Brix with the oligodextran having a mean molecular weight between 2,000 and 20,000 daltons.

In a further embodiment, the fat replacer composition also comprises one or more additives comprising a fat substitute, bulking agent, filling material, fat, lipid, oil, or combinations thereof. The fat substitute comprises a fat-based, carbohydrate-based, or protein-based fat substitutes. The fat-based fat substitutes comprise olestra, caprenin, and salatrim. The carbohydrate-based fat substitutes comprise dextrins, maltodextrins, gums, cellulose, gelatin, gels, fibers, pectins, cellulose, inulin, oatrim, polydextrose, polyols, starch, and modified food starches. The protein-based fat substitutes comprise microparticulated proteins and whey proteins. The bulking agent comprises polydextrose, hydrocolloids, erythritol, glucose syrups, psicose and lignin. Finally, the filling material comprises gels, creams, and other similar materials.

One embodiment comprises, as shown in the examples below, a reduced fat food product of a food product and a fat replacer. The reduced fat food product can comprise a number of different food products, including bakery products, including biscuits, donuts, cakes, pastries, muffins, breads, and cookies; snacks, including candied fruits, nougat crumbs, expanded snacks, dates, bars, chips, and dried fruits; confectionery products, including hard and soft candies, chewing gums, dragees, jelly beans; food fillings, jellies, jams, marmalades, chocopaste, fudges, honey, processed cheese, cream cheese, peanut butter, honey replacers, margarine, butter and lard. The fat replacer comprises an oligodextran along with fructose, glucose, leucrose and other oligosaccharides. The oligodextran of the fat replacer is between 75% d.s. Brix to 95% d.s. Brix, with a mean molecular weight (Mw) of 2,000 to 20,000 Daltons (Da), and is greater than 90% linear with α1,6 linkage in the main chain. The oligodextran's highly linear structure and low molecular weight allows it to effectively act as a fat replacer.

### EXAMPLES

Aspects of the method for producing a fat replacer and a fat replacer composition that can be used in a variety of food product are illustrated in the following examples. In these examples, it is shown that successful production of a low molecular weight oligodextran mixture that can be used as a fat replacer is achievable by the process disclosed.

### Example 1

In the first example, the objective is produce approximately 10 kg of an oligodextran mixture with a molecular weight (Mw)≈5000-10000 daltons from a syrup mixture of sucrose (commercially available as saccharose) and maltose (from Cargill, Incorporated) in a ratio of 40:1 w/w using a dextransucrase enzyme from the Leuconostoc mesenteroides B-512F strain. The syrup mixture is incubated for a time of hours to form an oligodextran mixture that has a low molecular weight (referred to as NCP 103 for this example). Operating conditions include the following: One DNS unit of enzyme per gram of sugar is added to sucrose/maltose syrup mixture (ratio 40/1) and operated at a pH 5.5, a temperature of 30° C. for a time of 48 hours. The resulting oligodextran composition contains 14% oligodextran in the molecular weight range between 1557 and 3177 dalton and 18% in the molecular weight range between 3177 and 7389 dalton. The oligodextran composition produced is then demineralized and concentrated to 75% d.s. Brix for use as a fat replacer.

The production of oligodextran includes preparing a 20 liter (L) solution comprising 9756g of sucrose with 244 g of maltose in a ratio 40/1 at 50% ds (w/v). One enzyme DNS units/g sugar is added and the mixture is incubated at pH 5.5 (the pH solution as is), at a temperature of 30° C. for a time of 48 hours. The pH of the syrup mixture is decreased to 3 with hydrogen chloride acid (HCl) and heated to a temperature of 70° C. for two hours to deactivate the enzyme. The oligodextran mixture samples are analyzed with HPLC by using two different HPLC systems.

a) Oligosaccharides analyis: A Bio-Rad de-ashing cartridge as guard column was used, followed by 2 X Bio-Rad Aminex HPX-42A in series (cation exchange columns, silver form, length 300 mm—Diameter: 7.8 mm—particle size 9 μm—Column temperature: 85° C.). The eluent, HPLC-grade water, was heated (±50° C.) and stirred. Detection was done with a refractive index detector.
The flow rate was 0.6 ml/min, using HPLC grade water. The injection volume was 2 μl (if solution is at 10% dry substance).
b) GPC analysis: A Bio-Rad de-ashing cartridge as guard column was used followed by 2 Shodex columns KS804+KS802 (sodium from each 30 cm length, in series at 75° C.). The eluent was HPLC-grade water, filtered through 0.45 μm filter, degassed, and maintained at about 70° C. Detection was done with a refractive index detector, the flow rate was 0.8 ml/min and the injection volume was 5 μl at 10-15% d.s. Data acquisition with Atlas 2003R2 (Thermo Fisher). Data processing with Caliber (GPC package from Polymer Labs) Results are expressed in Mn, Mw, polydispersivity, slicing and DE.

Composition of oligodextran (NCP 103):

| Peak Name | Area % |
|---|---|
| DP n | 25.6 |
| DP 11 | 2.0 |
| DP 10 | 1.8 |
| DP 9 | 1.8 |
| DP 8 | 1.9 |
| DP 7 | 1.8 |
| DP 6 | 1.8 |
| DP 5 | 2.0 |
| DP 4 | 1.4 |
| DP 3 | 1.2 |
| DP 2 | 3.1 |
| Leucrose | 17.1 |
| Dextrose | 1.2 |
| Fructose | 37.4 |

The resulting oligodextran composition contains 14% oligodextran in the molecular weight range between 1557 and 3177 dalton and 18% in the molecular weight range between 3177 and 7389 dalton. As seen from the GPC analysis:

Incubation time (hrs) = 48

| | |
|---|---|
| Mp = 175 | Mz = 633315 |
| Mn = 332 | Mz + 1 = 788758 |
| Mw = 9625 | Mv = 9625 |

Polydispersity = 28.953

| High Mw. | Low Mw. | Cum. Height | Mp |
|---|---|---|---|
| 909 | 156 | 60.85 | 176 |
| 1557 | 909 | 5.08 | 1554 |
| 3177 | 1557 | 14.25 | 3169 |
| 7389 | 3177 | 18.08 | 3699 |
| 20349 | 7389 | 0.19 | 7391 |
| 45459 | 20349 | 0.08 | 31857 |
| 97299 | 45459 | 0.16 | 96404 |
| 243828 | 97299 | 0.24 | 239508 |
| 947231 | 243828 | 1.08 | 289632 |

The syrup produced was then demineralized and concentrated to 75% ds Brix for use as a fat replacer.

### Example 2

In this example, freeze-dried dextransucrase enzymes from Cargill (Leuconostoc mesenteroides B-512F), Incorporated are used in the process with different ratios of sucrose and maltose at 20:1, 25:1, 30:1, and 40:1 (w/w) with 3U/g of sugar. The Brix value of FM3 is 39.7% versus 50.7% for reaction mixtures FM1, FM2, FM4. The operating conditions are 30° C. and 42% ds.

| | ratio | Incub | | | | | | | | | | | | | | | |
|---|---|---|---|---|---|---|---|---|---|---|---|---|---|---|---|---|---|
| Incub | Sx/acc | Time (H) | sucr | leuc | Dx | fru | DP2 | DP3 | DP4 | DP5 | DP6 | DP7 | DP8 | DP9 | DP10+ | DP3-11+ | DPn |
| FM1 | 20:1 | 0.0 | 90.7 | 0 | 0 | 0.2 | 2.0 | 0.3 | 0.0 | | | | | | | 0.3 | 0.3 |
| | | 21.8 | 31.7 | 9.8 | 2.0 | 23.8 | 1.1 | 0.4 | 0.6 | 0.8 | 0.8 | 0.9 | 1.0 | 1.2 | 8.9 | 14.6 | 2.3 |
| | | 64.5 | 0.4 | 14.1 | 0.9 | 33.4 | 2.1 | 1.0 | 1.4 | 1.9 | 1.9 | 2.2 | 2.4 | 2.9 | 19.2 | 32.9 | 10.8 |
| FM2 | 25:1 | 0.0 | 87.9 | 0.0 | 0.0 | 0.8 | 3.0 | 0.7 | 0.1 | | | | | | | 0.8 | 0.6 |
| | | 21.8 | 38.3 | 10.9 | 1.8 | 18.0 | 1.2 | 0.6 | 1.0 | 1.7 | 2.2 | 2.3 | 2.6 | 2.9 | 8.0 | 21.3 | 3.1 |
| | | 64.5 | 0.3 | 14.7 | 1.0 | 33.5 | 2.2 | 1.1 | 1.5 | 1.9 | 1.9 | 2.1 | 2.1 | 2.5 | 16.7 | 29.8 | 13.1 |
| FM3 | 30:1 | 0.0 | 87.2 | 0.0 | 0.0 | 1.1 | 2.4 | 0.8 | 0.2 | | | | | | | | 0.7 |
| | | 21.8 | 0.7 | 17.3 | 1.2 | 32.3 | 2.2 | 1.1 | 1.6 | 2.1 | 2.0 | 2.1 | 2.1 | 2.3 | 14.6 | 27.9 | 15.0 |
| | | 64.5 | 0.0 | 14.7 | 2.2 | 31.8 | 2.6 | 1.3 | 1.5 | 1.9 | 2.1 | 2.1 | 2.1 | 2.3 | 13.7 | 27.0 | 15.3 |
| FM4 | 40:1 | 0.0 | 90.7 | 0.0 | 0.0 | 0.0 | 2.0 | 0.3 | 0.0 | | | | | | | | 0.3 |
| | | 21.8 | 31.7 | 9.8 | 1.3 | 23.8 | 1.1 | 0.4 | 0.6 | 0.8 | 0.8 | 0.9 | 1.0 | 1.2 | 8.9 | 14.6 | 13.7 |
| | | 64.5 | 1.7 | 10.0 | 1.2 | 36.7 | 1.9 | 0.7 | 0.9 | 1.1 | 1.0 | 1.0 | 1.1 | 1.1 | 5.5 | 12.4 | 30.2 |

The results of the tests using HPLC analysis of the oligodextran mixture including oligodextrans and other compounds present such as fructose are in the table below. Syrup mixture FM3 needed only approximately one day (21.8 hours) to have a complete conversion of sucrose as shown by the 0.7% area of sucrose by HPLC, whereas the other syrup mixtures needed a longer incubation time.

The oligodextran mixtures of this example 2 (FM1, FM2, FM3, and FM4) and example 1 (NCP 103) are analyzed for their molecular weight (GPC low MW) and compared with the composition of the M40/1 syrup (NCP103). In the next table, their percentage of MW splits are given.

| MW range | | | | | |
|---|---|---|---|---|---|
| (Daltons) | FM1 | FM2 | FM3 | FM4 | NCP103 |
| 909-173 | 59.1 | 60.2 | 61.0 | 58.2 | 62.4 |
| 1557-909 | 9.6 | 8.7 | 8.4 | 4.2 | 7.3 |
| 3177-1557 | 26.3 | 25.1 | 23.1 | 16.9 | 18.9 |
| 7389-3177 | 2.8 | 3.9 | 5.5 | 15.6 | 9.2 |
| 20349-7389 | 0.2 | 0.1 | 0.2 | 0.4 | 0.3 |
| 45459-20349 | 0.2 | 0.1 | 0.2 | 0.1 | 0.2 |
| 97299-45459 | 0.2 | 0.1 | 0.2 | 0.1 | 0.2 |
| 243828-97299 | 0.1 | 0.1 | 0.2 | 0.1 | 0.2 |
| 1000038-243828 | 1.6 | 1.7 | 1.3 | 4.4 | 1.2 |

Based on the results of these tests, while the ratios of sucrose to maltose of 20:1 and 25:1 will work, a preferred embodiment is in a ratio of 30:1 to 40:1. In another preferred embodiment, the ratio is 35:1. With longer incubation times, it is preferable to purify the enzyme by dialysis.

### Example 3

In Example 3, testing is done to reduce the amount of fructose content in the resulting oligodextran compound by using immobilized glucose isomerase (Gensweet IGI-VHF, Genencor). Therefore a larger amount of oligodextran mixture is made. 11 of solution at 42% d.s (w/w) with 3 U/g sugar at a ratio 35:1 sucrose/maltose (w/w) at 30° C. is made. An oligodextran mixture with the following composition is obtained:

| | | ratio | Incub | | | | | | |
|---|---|---|---|---|---|---|---|---|---|
| Incub | acceptor | Sx/acc | Time (H) | sucr | leuc | Fru | Dex | DP2-6 | DPn |
| FM11 | maltose | 35/1 | 48.0 | 0.0 | 11.6 | 36.5 | 2.0 | 4.1 | 32.3 |

To 600 g of the FM11 syrup, 100 ppm Mg²⁺ is added and the syrup is put at pH 7.5. The syrup is pumped at a flow of 2BV/H over a 20 ml IGI conjugate in a column heated to 40° C. A syrup called, “isomerized FM11”, with the following composition is obtained:

| Component | Area % |
|---|---|
| DPn | 44.5 |
| DP2-6 | 3.9 |
| Maltose | 1.8 |
| Leucrose | 10.8 |
| Dextrose | 19.7 |
| Fructose | 19.6 |

### Example 4

In example, 4, ultrafiltered dextransucrase along with VHMS (very high maltose syrup, C*Sweet M10170 from Cargill, containing 68.8% DP2 and 21.3% DP3) is used as an alternative acceptor. The amount of VHMS used in sample FM12 is based on the DP2 content of the very high maltose syrup as well as taking into account the dry substance (d.s.). For sample FM13 the DP2 and DP3 content of the very high maltose syrup has been taken into account. This is also done for the maltose sample FM14, as it is not a commercial compound, but one made in the laboratory with 96.7% DP2. The VHMS contains 68.8% DP2 and has a ds of 79.2%. The incubation time is 42 hours, which allows conversion of the sucrose, as seen in the table below.

| | | | | | | Incub | | | | |
|---|---|---|---|---|---|---|---|---|---|---|
| Incub | T | U/g | (w/w) | acceptor | ratio | Time (H) | sucr | leuc | Fru | Dex |
| FM12 | 30 | 3 | 42 | VHMS: DP2 | 35/1 | 42 | 0.0 | 10.6 | 36.8 | 1.7 |
| FM13 | | | | VHMS: DP2 + DP3 | | 42 | 0.0 | 11.0 | 36.4 | 1.9 |
| FM14 | | | | maltose | | 42 | 0.0 | 10.8 | 36.9 | 1.7 |

| Incub | DP2 | DP3 | DP4 | DP5 | DP6 | DP7 | DP8 | DP9 | DP10+ | DPn |
|---|---|---|---|---|---|---|---|---|---|---|
| FM12 | 2.2 | 1.0 | 1.3 | 1.4 | 1.3 | 1.3 | 1.4 | 1.5 | 5.5 | 31.1 |
| FM13 | 2.2 | 1.0 | 1.2 | 1.4 | 1.2 | 1.2 | 1.3 | 1.3 | 4.4 | 32.7 |
| FM14 | 2.1 | 0.8 | 1.1 | 1.2 | 1.1 | 1.1 | 1.1 | 1.3 | 4.4 | 33.4 |

### Example 5

In Example 5, the tests are run with varying amounts of the Lactostab™ bacteriostatic, specifically in the amounts of 0, 20 and 100 ppm. The operating conditions are in the table below. The incubation time is about 24 hours.

| | | | | | | | | acceptor reaction conditions | | | | | | | |
|---|---|---|---|---|---|---|---|---|---|---|---|---|---|---|---|
| | un- | | | | | | | | | | | g | 100, 0 | | |
| | diluted | | DNS | | | | g | | | | acetate | enzyme | or 20 ppm | | |
| | DNS | | U/g | % d.s. | | ratio | reac- | g | g | g | buffer | with | Lactostab | ml | Total mg |
| Incub | U/g | T | sugar | w/w | acceptor | Sx/acc | tion | sugar | VHMS | sucrose | pH 5.4 | pipette | 1/10 (μl) | water | protein |
| FM21 | 13.0 | 30 | 3 | 42 | VHMS | 35/1 | 25.0 | 10.5 | 0.44 | 10.2 | 2.50 | 2.4 | 25.0 | 9.43 | 0.8 |
| FM22 | | | | | DP2 + | | | | | | pH as | | 0.0 | 11.93 | |
| | | | | | DP3 | | | | | | is | | | | |
| FM23 | | | | | | | | | | | 0.00 | | 5.0 | | |

As indicated in the following table, the conversion was not completed after 24 hrs. Lactostab had no influence on the conversion.

| | | Incub | | | | | | | | | | | | | | | |
|---|---|---|---|---|---|---|---|---|---|---|---|---|---|---|---|---|---|
| Incub | Lactostab | Time | | | | | | | | | | | | | | | |
| tube nr | ppm | (H) | DP2 | sucr | leuc | Fru | Dex | DP3 | DP4 | DP5 | DP6 | DP7 | DP8 | DP9 | DP10+ | DP3-11+ | DPn |
| FM21 | 100 | 24 | 28.3 | 26.6 | 7.7 | 25.9 | 2.8 | 0.9 | 1.1 | 1.2 | 1.1 | 1.1 | 1.2 | 1.4 | 1.7 | 9.7 | 19.8 |
| FM22 | 0 | 23 | 40.7 | 39.3 | 5.3 | 21.9 | 2.7 | 0.8 | 1.0 | 1.1 | 1.1 | 1.2 | 1.3 | 1.5 | 6.0 | 14.0 | 12.8 |
| FM23 | 20 | 23 | 41.8 | 40.5 | 5.1 | 21.5 | 2.8 | 0.8 | 1.0 | 1.1 | 1.1 | 1.2 | 1.3 | 1.6 | 6.1 | 14.2 | 12.4 |

The results of the tests overall show that a fat replacer can be produced by the method disclosed of mixing a saccharide and an acceptor to form a syrup mixture which is then incubated with an enzyme to form an oligodextran mixture, the enzyme is deactivated, and the oligodextran mixture is demineralized and concentrated.

### Example 6

In the following examples, the fat replacer produced from the methods above is used in a variety of food products. In Example 6, the fat replacer is used to reduce the fat amount by 25% in pound cakes. The two samples of the oligodextran fat replacer are from Examples 1 and 3, with Example 1 “OD old: NCP 103” having a brown-white colour, and Example 3 “OD new: isomerized FM 11” and having a white colour. The procedure consisted of adding the margarine and oligodextran together in a Hobart N50 mixer bowl and mixing at low speed (speed 1) with a paddle. Subsequently, the cake mix is added and mixed with Hobard at speed 1. Eggs are added at 20° C. and mixed for 5.5 minutes at medium speed with a Hobart mixer with a paddle. Four cakes are scaled (400 g) and baked at conventional conditions of 175° C. for 55 minutes with an extra plate in the oven to avoid heating. The recipe is in the table below.

Recipe:

| | Ref | Ref. | OD new | OD old |
|---|---|---|---|---|
| fat replacement (%) | % | 0 | 25 | 25 |
| Cake mix | 50 | 1000 | 1000 | 1000 |
| Margarine | 25 | 500 | 375 | 375 |
| Eggs | 25 | 500 | 500 | 500 |
| OligoDextran | 0 | 0 | 125 | 125 |
| Total | 100 | 2000 | 2000 | 2000 |

The following measurements were made on the final product: volume and weight with TexVol instrument BVM-L370, color with Minolta, texture with TA.XT plus texture analyser, water activity with aqualab CX-2, moisture with Sartorius Infrared balance, crumb color and sensory evaluation results. The dough behavior on the batter is given in the following table (reference is full margarine receipt):

| | | | | | Batter |
|---|---|---|---|---|---|
| | | | | | viscosity |
| | | Batter | g white | Spec. | in loadgram |
| | | temp. | cup | volume | S.T.A. depth |
| | | ° C. | 500 ml | cm³/g | 25 mm cone |
| Trial 1 | reference | 20.3 | 391.3 | 1.278 | 78 |
| Trial 2 | OD new | 20.8 | 396.6 | 1.261 | 68 |
| Trial 3 | OD old | 20.7 | 388.5 | 1.287 | 72 |

The highest specific volume is obtained with OD old, while the lowest batter viscosity measured with a Stevens Mechtric LFRA texture analyser is obtained with OD new (i.e. the sample low in fructose).

The weight loss during baking and cooling down was also measured. The weight of the four cakes is measured before baking, just after leaving the oven, and after one hour of cooling down. The following table gives the results:

| | | % loss during | % loss after |
|---|---|---|---|
| | | baking | cooling down |
| Trial 1 | reference | 2.9 | 1.5 |
| Trial 2 | OD new | 3.0 | 1.5 |
| Trial 3 | OD old | 3.1 | 1.5 |

Similar weight losses are obtained for all the cakes.

A visual observation was done on the final products:

The shape and crust evaluation are summarized in the next table:

| D + 1 | | Shape | Colour | sticky |
|---|---|---|---|---|
| Trial 1 | reference | good baking behaviour, flat | brown | no |
| | | on top, no crumbly crust | | |
| Trial 2 | OD new | good baking behaviour, slightly | brown | no |
| | | round on top, no crumbly crust | | |
| Trial 3 | OD old | good baking behaviour, flat | slightly | no |
| | | on top, no crumbly crust | browner | |

A bigger volume is obtained with the dextran cakes compared to the reference and the color of the OD old (i.e. with most fructose) is more brown.

Also the volume of the cakes was determined by TexVol instrument BVM-L370:

| | | | Volume | Height | Width | Depth | Area | Spec. Volume | Weight |
|---|---|---|---|---|---|---|---|---|---|
| D + 1 | | | ml | mm | mm | mm | cm2 | ml/g | g |
| Trial 1 | reference | average | 1073 | 88 | 222 | 127 | 167 | 2.971468 | 361 |
| Trial 2 | OD new | of all | 1126 | 95 | 221 | 121 | 164 | 3.132151 | 360 |
| Trial 3 | OD old | cakes | 1138 | 92 | 221 | 123 | 167 | 3.164365 | 360 |

Higher volumes and specific volumes are obtained with OD old and OD new compared to the reference.

The following picture is giving the color of the crumb:

Due to the visible Maillard reaction in the cake OD old, it was decided to measure also the colour of the crumb. The color is measured with Minolta.

Colour Minolta

| | | | | |
|---|---|---|---|---|
| D + 21 | L* | a* | b* | C* |

| | | | | | |
|---|---|---|---|---|---|
| Trial 1 | reference | 97.14 | 0.25 | 2.58 | 2.59 |
| Trial 2 | OD new | 95.32 | 1.96 | 1.48 | 2.46 |
| Trial 3 | OD old | 92.96 | 2.55 | 3.18 | 4.08 |

The cake with OD old has a higher color. The OD new (with less fructose) has a very good color.

After 1, 6 and 21 days of baking, the texture was analyzed with TA.XT plus texture analyser on the pound cakes. The following graph gives an overview of the results.

Both cakes with the oligodextrans are softer compared to the reference. Even after 21 days the cakes remain softer than the reference cake.

Results of the measurement of the water activity (aw) with Aqualab CX-2 and moisture content with Sartorius Infrared balance are given in following table:

| | | D + 1 | | | D + 6 | | | D + 21 | | |
|---|---|---|---|---|---|---|---|---|---|---|
| | | | aw temp | Moisture | | aw temp | Moisture | | aw temp | Moisture |
| | | aw | (° C.) | (%) | aw | (° C.) | (%) | aw | (° C.) | (%) |
| Trial 1 | reference | 0.89 | 24.2 | 25.45 | 0.856 | 24.8 | 21.55 | 0.836 | 23.1 | 19.81 |
| Trial 2 | OD new | 0.883 | 23.8 | 26.22 | 0.839 | 25.1 | 21.14 | 0.813 | 23.6 | 19.63 |
| Trial 3 | OD old | 0.878 | 23.5 | 24.76 | 0.834 | 25.1 | 21.19 | 0.813 | 23.9 | 19.21 |

The aw-values of the oligodextrans are lower than the reference. Similar results are obtained for the moisture content.

Also sensory evaluation was done as noted in the following table:

| D + 1 | | Structure | Texture | Crumb colour | wet/dry | Aroma | Edibility |
|---|---|---|---|---|---|---|---|
| Trial 1 | Ref | fine, regular | soft | yellow | in | butter | eats good away, |
| | | | | | between | | soft, not dry |
| Trial 2 | OD new | fine, regular, | very | yellow with | wetter | less | slightly dryer, |
| | | coarser than ref | soft | Maillard (halt) | | | soft, eats easily |
| | | | | | | | away, less energy |
| Trial 3 | OD old | fine, regular, | very | yellow with | dry | less than | slightly dryer, |
| | | coarser than ref new | soft | Maillard (¾) | | OD new | soft, more energy |
| | | | | | | | than OD new |

The crumb of OD old shows very clear Maillard reaction. A slightly bitter off taste is present. With OD new the Maillard reaction is less and no bitter off taste is present. 25% replacement of the fat in pound cake with (Oligodextran) results in a cake with good baking behavior and edibility. The fructose reduced oligodextran (OD new, FM11 from example 4-3) especially gives very good functionalities and has also a reduced tendency to give browning reactions.

### Example 7

In the next example with pound cake, testing is done with 25% and 33% fat reduction compared to a reference sample with no fat replacer added. The procedure for baking is the same as in Example 6. The recipe is below. The oligodextran mixture used is the OD old (NCP103) produced in example 1. Two fat replacement percentages are done: recipe OD1 is with 25% margarine substitution by OD old, recipe OD2 is with 33% margarine substitution by OD old.

| | Recipe: | | |
|---|---|---|---|
| | | OD1 | OD2 |
| fat replacement (%) | Ref. | 25 | 33 |
| Cake mix | 1000 | 1000 | 1000 |
| Margarine | 500 | 375 | 335 |
| Water | 0 | 0 | 0 |
| Eggs | 500 | 500 | 500 |
| OligoDextran | 0 | 125 | 165 |
| Total | 2000 | 2000 | 2000 |

The results on the batter in the table below show that the highest specific volume was obtained with OD1 (25% Oligodextran) and the lowest batter viscosity was obtained with OD2 (33% Oligodextran).

| | | | | | Batter |
|---|---|---|---|---|---|
| | | | | | viscosity |
| | | Batter | g white | | in loadgram |
| | | temp. | cup | Spec. | S.T.A. depth |
| | | ° C. | 500 ml | volume | 25 mm cone |
| Trial 1 | reference | 20.7 | 379.9 | 1.316 | 80 |
| Trial 2 | OD1 | 21.8 | 377.2 | 1.326 | 63 |
| Trial 3 | OD2 | 22.1 | 388.6 | 1.287 | 58 |

The weight loss is also measured on the four cakes tested before baking and just after leaving the oven. The results in the table below show that higher replacement of the fat by the oligodextran fat replacer results in slightly more weight loss during baking.

| | | | | % loss |
|---|---|---|---|---|
| | | Weight before | Weight after | during |
| | | baking | baking | baking |
| Trial 1 | reference | 3466.5 | 3374.7 | 2.6 |
| Trial 2 | OD1 | 3429.7 | 3326.6 | 3.0 |
| Trial 3 | OD2 | 3466 | 3351 | 3.3 |

Volume determination is also made between the samples. Higher volumes and specific volumes are obtained with the fat replacers compared to the reference sample.

| | | | Volume | Height | Width | Depth | Area | Spec. Volume | Weight |
|---|---|---|---|---|---|---|---|---|---|
| D + 1 | | | ml | mm | mm | mm | cm2 | ml/g | g |
| Trial 1 | reference | average | 1101 | 93 | 220 | 106 | 169 | 3.024116 | 364 |
| Trial 2 | OD1 | of all | 1174 | 94 | 215 | 103 | 167 | 3.246097 | 362 |
| Trial 3 | OD2 | cakes | 1186 | 97 | 217 | 100 | 167 | 3.300567 | 359 |

After one day of baking, the texture of the pound cake samples is analyzed as well. The softest cake is the OD2 33% fat reduced sample, whereas the hardest cake is the reference sample.

| | | Texture | | | | Average | | aw temp |
|---|---|---|---|---|---|---|---|---|
| D + 1 | | g | | | | texture (g) | aw | (° C.) |
| Trial 1 | reference | 1104.202 | 1105.009 | 1048.794 | 1067.909 | 1081.479 | 0.88 | 23.5 |
| Trial 2 | OD1 | 947.415 | 854.343 | 846.197 | 826.115 | 868.518 | 0.875 | 23.9 |
| Trial 3 | OD2 | 828.777 | 866.28 | 873.377 | 891.12 | 864.889 | 0.871 | 23.8 |

After four days, the crumb hardness is once again measured. The softest cake is the OD1 oligodextran sample with 25% fat reduction. Both oligodextran samples remain softer after four days than the reference sample.

| | | Texture | | | | Average | | aw temp |
|---|---|---|---|---|---|---|---|---|
| D + 4 | | g | | | | texture (g) | aw | (° C.) |
| Trial 1 | reference | 1400.678 | 1362.207 | 1377.127 | 1507.46 | 1411.868 | 0.872 | 22.9 |
| Trial 2 | OD1 | 1408.904 | 1212.356 | 1188.886 | 1348.254 | 1289.600 | 0.854 | 23.3 |
| Trial 3 | OD2 | 1434.793 | 1320.913 | 1208.243 | 1321.236 | 1321.296 | 0.837 | 23.4 |

Visual and sensory evaluations are also made on the samples. The results are summarized in the picture and table below. Fat replacer cakes OD1 and OD2 are more irregular than the reference cake. A bigger volume is obtained with the OD1 and OD2 fat replacer cakes compared to the reference. The color of the fat replacer cakes OD 1 and OD2 are more brown than the reference cake.

| D + 1 | | Shape | Colour | sticky on top |
|---|---|---|---|---|
| Trial 1 | reference | good | yellow- brown | wet on top |
| Trial 2 | OD1 | irregular, more | brown, slightly | wet on top |
| | | volume than ref | darker than ref | |
| Trial 3 | OD2 | more irregular | slighlty darker | slightly |
| | | than OD1, bigger | than OD1 | sticky |
| | | volume than ref | | |

The crumb of each of the samples is also evaluated, along with taste. The crumb of OD 2 (33%) shows very clear Maillard reaction and is not acceptable. This results also in a bitter off taste of the crumb. With OD1 (25% fat replacement), the Maillard reaction is less but a slight bitter off taste is present.

| | | | Crumb | | |
|---|---|---|---|---|---|
| D + 1 | | Structure | colour | Aroma | Edibility |
| Trial 1 | refer- | open regular | yellow | butter | soft, melting |
| | ence | cells | | | |
| Trial 2 | OD1 | open, | start of | less | somewhat sweeter |
| | | regular, | Maillard | | than ref, soft, |
| | | | | | melting, no |
| | | | | | crumble, missing |
| | | | | | of butter flavour, |
| | | | | | slightly bitter |
| | | | | | off taste |
| Trial 3 | OD2 | more open, | Maillard, | no | dryer, more energy |
| | | irregular, | not | | to eat, falls apart, |
| | | coarse | acceptable | | bitter taste |

The results overall show good volume and good edibility, with a bitter taste, although it could be optimized with the addition of flavors. The results of the testing show that 33% fat replacement with the oligodextran fat replacer results in a larger volume than the reference, darker crumb color, a Maillard reaction visible on the crumb, and a bitter taste on the crumb. The results of the testing show that 25% fat replacement with the oligodextran fat replacer results in a slightly larger volume than the reference, a slightly darker crumb color, the beginning of a Maillard reaction visible on the crumb, a soft, melting cake, and a slightly bitter taste on the crumb, and less butter aroma. The 25% fat replacement is the preferred product.

### Example 8

The objective of the following examples is to test and evaluate the use of the oligodextran fat replacer in a food product of biscuits (cookies) to achieve a 25% and 33% fat reduction. The table below shows the recipe for the biscuits with 25% fat replacement, 33% fat replacement, and a reference with no oligodextran fat replacer added.

| | Ref | OD1 | OD2 |
|---|---|---|---|
| | Fat replacement (%) | | |
| Ingredients | 0 | 25 | 33 |
| Margarine (St Allery) | 155.9 | 116.9 | 104.4 |
| Sugar S2 | 134.8 | 134.8 | 134.8 |
| Salt | 5.9 | 5.9 | 5.9 |
| CIGel 20006 | 42.1 | 42.1 | 42.1 |
| Baking powder | 6.3 | 6.3 | 6.3 |
| Water | 54.8 | 54.8 | 54.8 |
| Duo flour edelweiss | 400.2 | 400.2 | 400.2 |
| Oligodextran | 0.0 | 39.0 | 51.4 |
| Total | 800.0 | 800.0 | 800.0 |

The procedure for making and baking the biscuits is as follows: Weigh margarine, oligodextran, sugar and salt in a Hobart mixer bowl and cream at speed 1 for 30 seconds with paddle. Add water and mix for 30 seconds, then scrape the bowl. Mix for 4 minutes. Add other dry ingredients (flour, baking powder, starch) while mixing until a homogenous dough is formed. Laminate dough with decreasing thickness: 20-15-7-3.5 mm. Pin hole the dough. Cut the biscuits with 60 mm form. Bake at 190° C. for 15 minutes; leave the biscuits on the plate and allow cooling down at room temperature for 1 hour.

The table below shows the evaluation of the batter and dough for each of the samples.

| | | Batter temp | |
|---|---|---|---|
| | | ° C. | Remark |
| Trial 0 | reference | 23.5 | very soft dough |
| Trial 1 | OD1 | 24.1 | dough slightly harder than ref |
| Trial 2 | OD2 | 24.4 | slightly longer to make ball, |
| | | | dough less staying together |

The next table shows the measurements of weight of ten biscuits, diameter of one biscuit, and height of ten biscuits before baking and after baking. The measurements for the oligodextran biscuits are comparable to the reference.

| | | | | | | | | % changes during baking | | |
|---|---|---|---|---|---|---|---|---|---|---|
| | | before baking ( mm) | | | after baking ( mm) | | | weight | height | diameter |
| | | weight | height | diameter | weight | height | diameter | loss | increase | spread |
| Trial 0 | reference | 105.5 | 37.6 | 60.2 | 90 | 57.1 | 62.7 | 14.7 | 51.9 | 4.2 |
| Trial 1 | OD1 | 105.8 | 37.0 | 59.2 | 91 | 59.2 | 61.8 | 14.0 | 60.0 | 4.4 |
| Trial 2 | OD2 | 108.5 | 39.3 | 60.4 | 94 | 61.2 | 62.1 | 13.4 | 55.7 | 2.8 |

One day after baking, the texture of each of the biscuits is analyzed. The biscuits with oligodextran are harder than the reference. The results are summarized in the table below.

| | | Texture | | | | | | | | | Average | Mois- |
|---|---|---|---|---|---|---|---|---|---|---|---|---|
| D + 1 | | g | | | | | | | | | texture (g) | ture (%) |
| Trial 0 | reference | 1774.659 | 2173.482 | 1764.013 | 1694.814 | 1388.257 | 1446.165 | 2097.992 | 1599.565 | 1741.996 | 1734.414 | 1.98 |
| Trial 1 | OD1 | 3151.545 | 2826.357 | 3470.28 | 2801.033 | 2585.612 | 2693.282 | 2610.533 | 3361.965 | 2864.264 | 2917.316 | 2.25 |
| Trial 2 | OD2 | 3366.482 | 3007.42 | 3244.698 | 3574.886 | 3384.064 | 3166.707 | 2994.919 | 3142.835 | 3152.916 | 3249.674 | 2.41 |

After seven days the texture is measured again, as seen in the table below.

| | | Texture | | | | | | | | | | Average |
|---|---|---|---|---|---|---|---|---|---|---|---|---|
| D + 7 | | g | | | | | | | | | | texture |
| Trial 0 | refer- | 2241.713 | 1864.425 | 1962.417 | 1645.939 | 1845.875 | 1500.605 | 1901.202 | 1809.904 | 1817.002 | 1800.71 | 1838.979 |
| | ence | | | | | | | | | | | |
| Trial 1 | OD1 | 3100.815 | 2858.053 | 2859.505 | 2437.132 | 3191.951 | 2607.227 | 2312.687 | 3188.483 | 2205.985 | 2969.433 | 2773.127 |
| Trial 2 | OD2 | 3300.267 | 3919.833 | 3261.715 | 3733.769 | 2888.137 | 2819.502 | 2731.834 | 3025.164 | 2634.164 | 3783.693 | 3209.808 |

After 30 days, the texture is again measured as summarized in the table below.

| | | Texture | | | | | | | | | | Average |
|---|---|---|---|---|---|---|---|---|---|---|---|---|
| D + 30 | | g | | | | | | | | | | texture |
| Trial 0 | refer- | 2255.585 | 2101.46 | 2035.568 | 1842.165 | 1958.707 | 1871.2 | 1965.965 | 2578.757 | 1752.48 | 1703.283 | 2006.517 |
| | ence | | | | | | | | | | | |
| Trial 1 | OD1 | 2896.04 | 2702.88 | 3009.921 | 3490.282 | 3337.689 | 3468.183 | 2886.282 | 2952.335 | 3056.295 | 2847.165 | 3064.707 |
| Trial 2 | OD2 | 4384.064 | 4195.984 | 3827.003 | 3966.046 | 3443.585 | 3820.712 | 4695.621 | 4011.856 | 3788.048 | 3883.54 | 4001.646 |

The table below shows in graphic representation a measure of hardness of the biscuits based on average texture in grams. The biscuits with 33% fat replacement by Oligodextran were much harder after 30 days compared to the biscuits with 25% fat replacement and the reference.

The next analysis is of the percentage moisture content of the biscuits after one, seven and 30 days.

| Moisture (%) | | D + 1 | D + 7 | D + 30 |
|---|---|---|---|---|
| Trial 0 | reference | 1.98 | 2.51 | 3.91 |
| Trial 1 | OD1 | 2.25 | 2.66 | 4.93 |
| Trial 2 | OD2 | 2.41 | 2.78 | 5.23 |

The next test is a visual and sensory evaluation of the samples. In the picture and two tables below, the biscuits are evaluated based on color, smell, physical texture and taste. The biscuits with 25% oligodextran fat replacer and 33% oligodextran fat replacer are acceptable for taste.

| D + 1 | | Colour |
|---|---|---|
| Trial 0 | reference | yellow |
| Trial 1 | OD1 | brown - redish |
| Trial 2 | OD2 | brown - redish but slightly |
| | | less coloured compared to OD1 |

| D + 1 | | Smell | Texture | Taste |
|---|---|---|---|---|
| Trial 0 | refer- | butter | easy to crack | soft, butter, |
| | ence | | | |
| Trial 1 | OD1 | caramel - burned | more difficult | dryer, harder bite, |
| | | sugar | | more crumbly |
| Trial 2 | OD2 | burned spraydried | similar as OD1 | dry, very crumbly |
| | | sugar | | |

Remarks and observations of the testing is that replacement of 33% fat by the oligodextran fat replacer results in a longer time to form the dough, brown color, burned smell, and harder biscuits after 30 days compared to the reference biscuits. For the replacement of 25% fat by the oligodextran fat replacer, in comparison to the reference, it has a slightly harder dough, has a brown color, burned smell, and similar softness to the reference. The conclusion is that the 25% and 33% replacement of the fat in the biscuit with Oligodextran results in acceptable biscuits.

As stated above, the foregoing is merely intended to illustrate various embodiments of the present invention. The specific modifications discussed above are not to be construed as limitations on the scope of the invention. It will be apparent to one skilled in the art that various equivalents, changes, and modifications may be made without departing from the scope of the invention, and it is understood that such equivalent embodiments are to be included herein. All references cited herein are incorporated by reference as if fully set forth herein.

We claim:

1. A method for producing a fat replacer, comprising:
a. Mixing a saccharide and an acceptor in a ratio of between 10:1 to 60:1 by weight in an aqueous solution to form a syrup mixture;
b. Treating the syrup mixture with an enzyme to form an oligodextran mixture; and
c. Concentrating the oligodextran mixture to form a fat replacer containing oligodextran.

2. The method of claim 1, wherein the ratio of the saccharide and the acceptor is of between 5:1 to 60:1 by weight (w/w), more preferably between 10:1 to 50:1 by weight (w/w), more preferably between 20:1 to 40:1 by weight (w/w).

3. The method of claim 1, wherein the saccharide comprises sucrose, wherein the acceptor comprises maltose, and wherein the enzyme comprises dextransucrase.

4. The method of claim 2, wherein the concentration of the enzyme is between 1.0 DNS to 3.0 DNS, and wherein the concentration of the fat replacer is between 60% dry solids (ds) Brix to 95% ds Brix and with the oligodextran component having a mean molecular weight (MW) of between 2,000 to 20,000 Daltons (Da).

5. The method of claim 1, wherein the treating step is performed at a pH of between 3.5 to 7.0, at a temperature of between 20° C. to 40° C. for a time of between 6 hours to 72 hours.

6. The method of claim 1, wherein the treating step is performed by a continuous immobilized enzyme process.

7. The method of claim 1 further comprising:
a. Deactivating the enzyme;
b. Filtering the oligodextran mixture; and
c. Demineralizing the oligodextran mixture.

8. The method of claim 5, wherein the enzyme deactivating step comprises adjusting the pH of the oligodextran mixture to a pH of between 2.0 to 3.2 or adjusting the temperature of the oligodextran mixture to a temperature of between 45° C. to 100° C. for a time of between 0.02 hours to 4 hours.

9. The method of claim 1, wherein the treating step is performed by incubating the syrup mixture with the enzyme at a pH of 5.5, at a temperature of 30° C. for a time of between 12 hours to 48 hours.

10. A fat replacer, comprising: an oligodextran, fructose, glucose, leucrose and other oligosaccharides, wherein the concentration of the fat replacer is between 60% ds Brix to 95% ds Brix. With the oligodextran having a mean molecular weight (MW) of between 2,000 to 20,000 Daltons (Da), and with more than 90% of the glucose moieties linked with α1,6 linkage in the main chain and less than 10% of the glucose moieties in the branches.

11. The use of the fat replacer of claim 9 in a food product, wherein the food product comprises bakery products, including biscuits, donuts, cakes, pastries, muffins, breads, and cookies; snacks, including candied fruits, nougat crumbs, expanded snacks, dates, bars, chips, and dried fruits; confectionery products, including hard and soft candies, chewing gums, dragees, jelly beans; food fillings, jellies, jams, marmalades, chocopaste, fudges, honey, processed cheese, cream cheese, peanut butter, honey replacers, margarine, butter and lard.

12. The use of the fat replacer in a food product of claim 10, further comprising adding one or more additives comprising a fat substitute, bulking agent, filling material, fat, lipid, oil, surface active agents (emulsifiers, surfactants), hydrocolloids, or combinations thereof.

13. The use of the fat replacer in a food product of claim 11, wherein the fat substitute comprises a fat-based, carbohydrate-based, or protein-based fat substitutes, wherein the fat-based fat substitutes comprises olestra, caprenin, and salatrim; wherein the carbohydrate-based fat substitutes comprise dextrins, maltodextrins, gums, cellulose, gelatin, gels, fibers, pectins, cellulose, inulin, oatrim, polydextrose, polyols, starch, and modified food starches; wherein the protein-based fat substitutes comprise microparticulated proteins and whey proteins; wherein the bulking agent comprises polydextrose, hydrocolloids, erythritol, glucose syrups, psicose and lignin; and wherein the filling material comprises gels, and creams.

14. A reduced fat food product comprising: a food product and a fat replacer, wherein the food product comprises bakery products, including biscuits, donuts, cakes, pastries, muffins, breads, and cookies; snacks, including candied fruits, nougat crumbs, expanded snacks, dates, bars, chips, and dried fruits; confectionery products, including hard and soft candies, chewing gums, dragees, jelly beans; food fillings, jellies, jams, marmalades, chocopaste, fudges, honey, processed cheese, cream cheese, peanut butter, honey replacers, margarine, butter and lard, and wherein the fat replacer comprises an oligodextran, fructose, glucose, leucrose and other oligosaccharides, wherein the oligodextran of the fat replacer is between 75% ds Brix to 95% ds Brix, a mean molecular weight (MW) of 2,000 to 20,000 Daltons (Da), and is greater than 90% linear with α1,6 linkage in the main chain.

15. The reduced fat food product of claim 13 further comprising one or more additives comprising a fat substitute, bulking agent, filling material, fat, lipid, oil, or combinations thereof.

16. The reduced fat food product of claim 14, wherein the fat substitute comprises a fat-based, carbohydrate-based, or protein-based fat substitutes, wherein the fat-based fat substitutes comprises olestra, caprenin, and salatrim; wherein the carbohydrate-based fat substitutes comprise dextrins, maltodextrins, gums, cellulose, gelatin, gels, fibers, pectins, cellulose, inulin, oatrim, polydextrose, polyols, starch, and modified food starches; wherein the protein-based fat substitutes comprise microparticulated proteins and whey proteins; wherein the bulking agent comprises polydextrose, hydrocolloids, erythritol, glucose syrups, psicose and lignin; and wherein the filling material comprises gels, or creams.

17. A method for producing a fat replacer, comprising:
a. Mixing a saccharide and an acceptor in a ratio of between 10:1 to 60:1 by weight in an aqueous solution to form a syrup mixture;
b. Treating the syrup mixture with an enzyme to form an oligodextran mixture;
c. Adding in a concentration of 0.05 to 10% on dry weight an agent that modifies the viscosity, texture or acts as plastizing agent. Examples are emulsifiers (lecithins, mono- or/and di-glycerides), hydrocolloids (carrageenans, pectins, alginates, galactomanans, xanthans), or other surface active agents.
d. Concentrating the oligodextran mixture to faun a fat replacer containing oligodextran
